(19) United States
(12) Patent Application Publication
(10) Pub. No.: US 2004/0064507 A1
(43) Pub. Date: Apr. 1, 2004

(54) Information providing system and device constituting the same

(76) Inventor: Tsuyoshi Sakata, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/048,779

(22) PCT Filed: May 30, 2001
(86) PCT No.: PCT/JP01/04564

(30) Foreign Application Priority Data
Jun. 2, 2000 (JP) 2000-166287

(51) Int. Cl. G06F 15/16

(52) U.S. Cl. 709/205

(57) ABSTRACT

The object of the invention is to provide an information provision system that can efficiently provide individual information to each terminal.

The invention is an information provision system that provides a content destined for a terminal, the content created by a content provider, wherein the information provision system includes a broadcast station for data-broadcasting a content and a content sending coordinator for requesting broadcast of a content created by the content provider from the broadcast station, acquiring from the broadcast station the information necessary for receiving the content, and presenting the information to a terminal via a communication circuit. The system transmits a content to a terminal via a broadcast system and transmits information necessary for receiving the content via a broadcast system to a terminal via a communications system, thereby allowing efficient provision of information.

### TECHNICAL FIELD

The present invention relates to an information provision system where individual information is provided to user terminals and the information is accumulated on the terminals and played back and viewed at an arbitrary point of time and apparatus that constitute the system, and in particular to an information provision system that enables efficient provision of information by using the routes of a broadcast system and a communications system, and apparatus that constitute the system.

### BACKGROUND OF THE INVENTION

It is now entering a stage of full-scale implementation of digital broadcasts. The digital broadcasts allows a variety of information provision via data broadcasts. In the data broadcasts, information related to a broadcast program, text information irrelevant to the broadcast program, and image information are multiplexed into a broadcast program or broadcast over an independent data broadcast channel.

In broadcasts, the same information is provided to a large number of viewers. A receiving terminal selects a source channel and accumulates data broadcast contents multiplexed into broadcast programs or contents on a channel dedicated to data broadcasts. The user manipulates a remote-controller unit to display the accumulated contents on the screen of the receiving terminal. In data broadcasts, the carousel transmission system is used to transmit contents repeatedly in order to reduce failure to acquire contents at a receiving party.

In recent years, the internet has been widespread across the nation. The user makes use of the internet as a communications system tool to gather information individually. In this system, the user enters the URL of a target server on the terminal to pull information on the server by using a WWW browser.

The internet provides, on top of the “pull-type” information, “push-type” information on a server that is supplied to a user terminal without user's operation. In this case, the terminal uses built-in client software to automatically access the server on a routine basis and extracts the news information on a field prespecified by the user.

While provision of information has been mainly done via paper such as newspapers and magazines, delivery of information by way of a network is expanding in this network era. It is expected that a push service that individually delivers news information to terminals of users that have entered subscription contracts, same as subscription to a newspaper, will be prevalent.

However, the related art information provision system has the following problems in an attempt to expand the service:

(1) Acquisition of information via the internet as a communications system requires a long communication time when the content is voluminous. Thus, the user may fail to view information on the terminal without delay. The communication cost mounts as the communication time gets longer. This limits the information volume of a content thus placing restrictions on provision of various interesting information.

(2) A system is envisaged where information provided by a server is transmitted via satellite links to a terminal on receipt of a request coming from the terminal in order to boost provision of information via the internet (a system to reduce a delay in information transmission by using satellite links). This approach involves a considerable time and cost for implementation of the related infrastructure.

Even when such a system is used, the data transmission bandwidth will be insufficient in case a large number of users are accommodated. In case the same information is requested with some delay in time, the same information is sent repeatedly. This is quite inefficient. For example, in case there are ten-thousand subscribers to network delivery of Newspaper A, the same news is transmitted ten-thousand times via satellite links in response to respective requests from the subscribers, which considerably impairs transmission efficiency.

(3) In a system where news information is broadcast via data broadcasts and subscribers are charged via limited receiving system, the content broadcast cannot be acquired at a receiving terminal in case the user is viewing a program on a separate channel when the information is being broadcast or in the case of disturbance due to bad weather. The broadcasts alone cannot assure that the content sent is acquired by the receiving party.

The invention solves such related art problems and aims at providing an information provision system that can efficiently provide individual information to each terminal and apparatus that constitute the system.

### DISCLOSURE OF THE INVENTION

In an information provision system according to the invention that provides a content destined for a terminal, said content created by a content provider, contents are transmitted to terminals via a broadcast system and information necessary for receiving a content to be received by each terminal among the contents (individual receive information) is transmitted to a terminal via a communications system.

The information provision system comprises a broadcast station for broadcasting the content via data broadcasts and a content sending coordinator for requesting broadcast of a content created by the content provider from the broadcast station, acquiring from the broadcast station the individual receive information as information necessary for receiving the content, and presenting the information to a terminal via a communication circuit.

The information provision system also comprises a plurality of broadcast stations for broadcasting the content via data broadcasts, a content sending coordinator for requesting broadcast of a content created by the content provider, acquiring from a broadcast station that broadcasts the content the individual receive information as information necessary for receiving the content, and presenting the information to a terminal via a communication circuit, and a content sending broker for selecting, in response to a request from the content sending coordinator, a broadcast station that broadcasts the content.

The information provision system further comprises a data communication server agent for accumulating the content onto a server on a network as well as setting access information to the server and a content sending coordinator for requesting accumulation of a content created by the content provider and presenting the access information set by the data communication server agent to a terminal via a communication circuit, and the content sending coordinator considers the content transmission cost, transmission time, traffic on the transmission path, and transmission data size before selecting said broadcast station or data communication server agent.

With this system, it is possible to efficiently transmit information to be provided to a terminal. This assures that the receiving party can acquire all the information of the contents to be provided via a broadcast system or a communications system. Thus, a content provider can perform authoring of a content without considering a content acquisition error.

A broadcast station can effectively use the idle broadcast time zones or idle bandwidths to provide a content transmission service as a business lineup. A content provider, even a small-scale business, can use this foundation to deliver contents via broadcasts. This system also produces a new business called a content sending broker for smoothly operating the foundation.

### BRIEF DESCRIPTION OF THE DRAWINGS

FIG. 1 is a block diagram showing the configuration of an information provision system in the first embodiment.

FIG. 2 shows the operation of an information provision system in the first embodiment.

FIG. 3 shows content's accessory information in the first embodiment.

FIG. 4 shows a content destination in the first embodiment.

FIG. 5 shows content's accessory information with a content group ID and a content ID appended in the first embodiment.

FIG. 6 shows a content destination list in the first embodiment.

FIG. 7 shows data broadcast request information in the first embodiment.

FIG. 8 shows broadcast schedule response information in the first embodiment.

FIG. 9 shows a delivery schedule information in the first embodiment.

FIG. 10 shows a content group list in the first embodiment.

FIG. 11 shows the delivery schedule information of the content group ID 5011 in the first embodiment.

FIG. 12 shows the content delivery schedule information of the terminal ID 1001 in the first embodiment.

FIG. 13 shows content's accessory information in the first embodiment.

FIG. 14 is a block diagram showing the configuration of an information provision system in the second embodiment.

FIG. 15 shows the operation of an information provision system in the second embodiment.

FIG. 16 shows a broadcast station selection criteria in the first embodiment.

FIG. 17 shows data broadcast request information in the second embodiment.

FIG. 18 shows bid information in the second embodiment.

FIG. 19 shows registration information of data broadcast schedule in the second embodiment.

FIG. 20 shows a delivery schedule information in the second embodiment.

FIG. 21 shows the delivery schedule information of the content group ID 5011 in the second embodiment.

FIG. 22 shows the content delivery schedule information of the terminal ID 1001 in the second embodiment.

FIG. 23 is a block diagram showing the configuration of an information provision system in the third embodiment.

FIG. 24 shows the operation of an information provision system in the third embodiment.

FIG. 25 shows content's accessory information in the third embodiment.

FIG. 26 shows a communication schedule information in the third embodiment.

FIG. 27 shows a delivery schedule information in the third embodiment.

FIG. 28 shows a content delivery schedule information in the third embodiment.

In the figures, a numeral 1 represents a content provider, 2 a content sending coordinator, 3, 6, 7 a broadcast station facility, 4 a broadcast receiver equipped with a communication feature, 5 a content sending broker, 8 a data communication server agent, 11 a content creation/delivery system, 12 a content storage server, 21 a send content acceptance/management server, 22 a data broadcast sending request system, 23 a data broadcast schedule management server, 24 a destination list acceptance/management server, 25 an individual schedule creation/management server, 31, 61, 71 a data broadcast sending acceptance system, 32, 62, 72 a data broadcast programming system, 33, 73 a data broadcast sending system, 41 content acquisition apparatus, 42 schedule acquisition apparatus, 43 internet cache apparatus, 44 an application, 51 a data broadcast sending request mediation system, 81 a data communication sending acceptance system, and 82 a data communication server.

### BEST MODE FOR CARRYING OUT THE INVENTION

(First Embodiment)

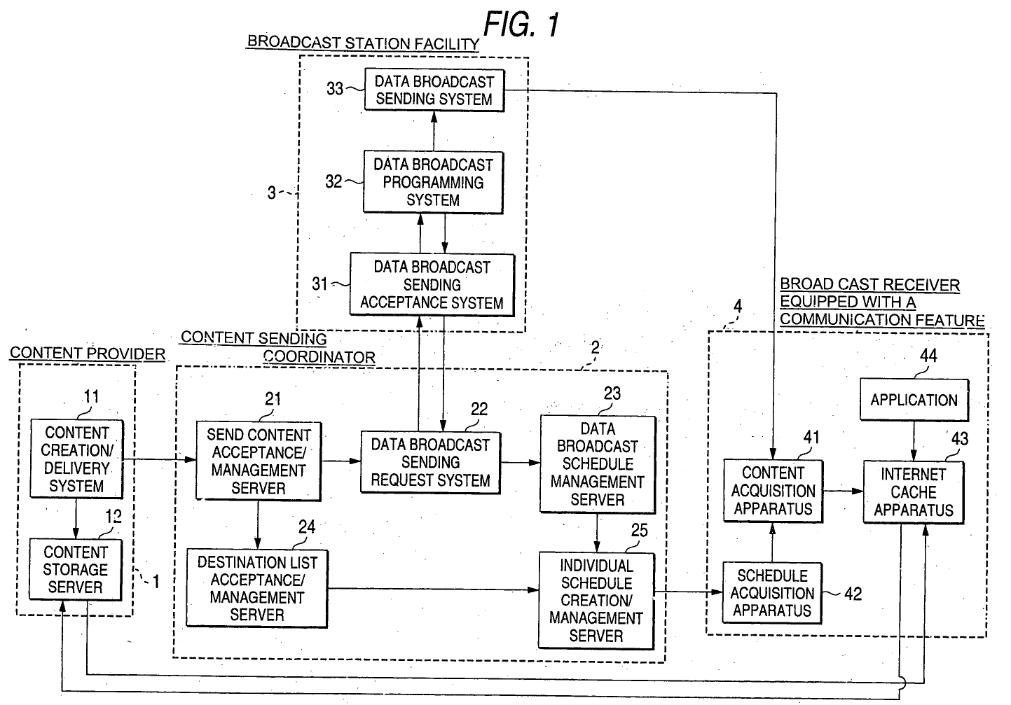

An information provision system according to the first embodiment comprises, as shown in FIG. 1, a content provider 1 for providing subscribing users with contents, a content sending coordinator 2 for scheduling contents broadcasts and communicating the contents broadcasts schedule to a user's receiving terminal, a broadcast station facility 3 for broadcasting the requested contents as scheduled, and broadcast receiver 4 equipped with a communication feature for receiving the broadcast contents and acquiring the contents via the internet in case it has failed to receive the contents.

The content provider 1 comprises a content creation/delivery system 11 for creating contents and delivering the contents to a content sending coordinator 2 and an internet content storage server 12 for storing created contents.

The content sending coordinator 2 comprises a send content acceptance/management server 21 for accepting and managing a content and a content destination list from the content provider 1, a destination list acceptance/management server 24 for accepting and managing the content destination list from the send content acceptance/management server 21, a data broadcast sending request system 22 for requesting broadcast of a content to the broadcast station 3 and receiving the schedule, a data broadcast schedule management server 23 for managing the received contents, and a individual schedule creation/management server 25 for creating and managing a broadcast schedule of contents for each receiver 4.

The broadcast station facility 3 comprises a data broadcast acceptance system 31 for accepting a content sending request from a content sending coordinator 2, a data broadcast programming system 32 for creating a content sending schedule hat has been requested, and a data broadcast sending system 33 for broadcasting a content according to a predetermined schedule.

The broadcast receiver 4 equipped with a communication feature comprises schedule acquisition apparatus 42 for receiving a content sending schedule from a content sending coordinator 2, content acquisition apparatus 41 for acquiring a content that has been data-broadcast, internet cache apparatus 43 for accumulating acquired contents, and an application 44 for playing back accumulated contents.

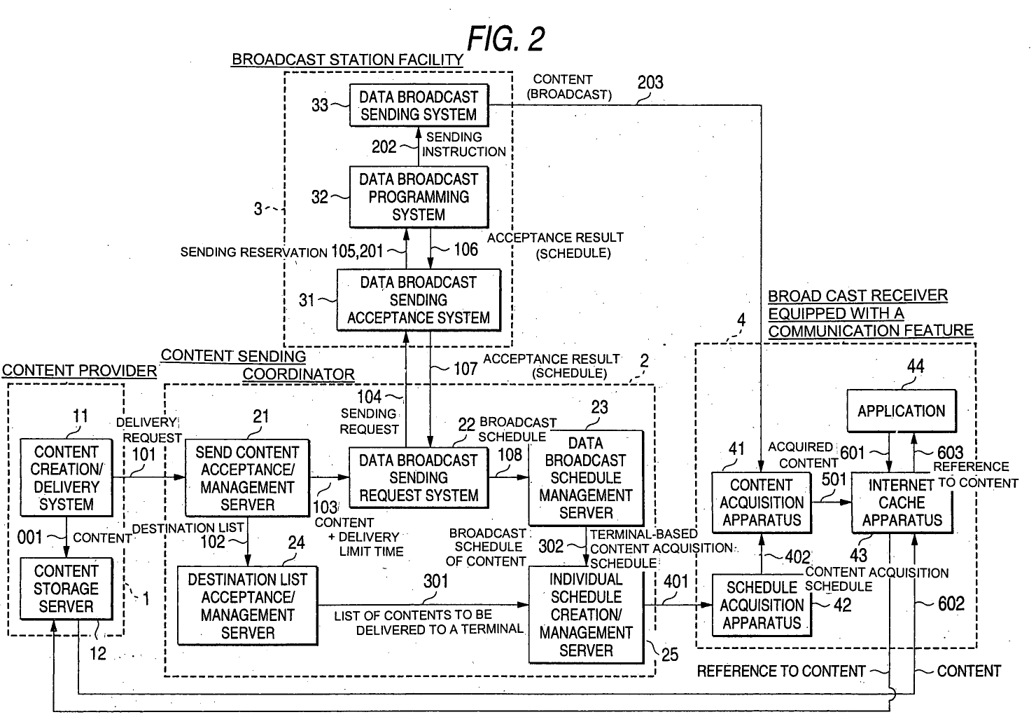

Operation of the system will be explained referring to FIG. 2. In FIG. 2, operation of each section in FIG. 1 is described with a number.

001: The content creation/delivery system 11 creates contents and registers the content with a web server (content storage server) 12. For example, a content corresponding to http://www.xxx.co.jp/cm/001/a.htm is placed in the directory cm/001 for the web server located at www.xxx.co.jp, under the name a.htm.

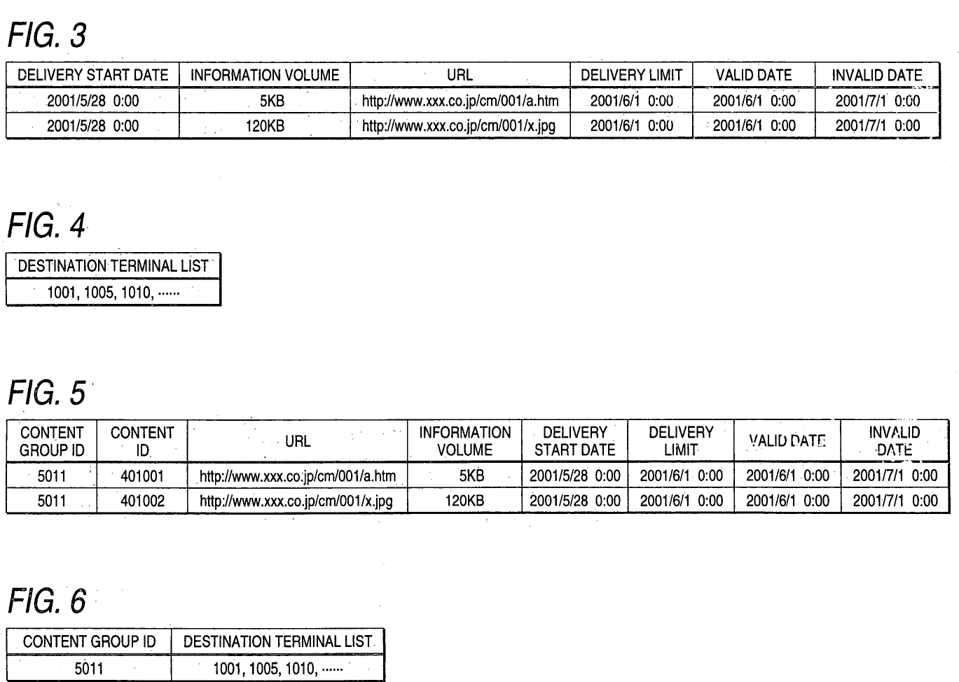

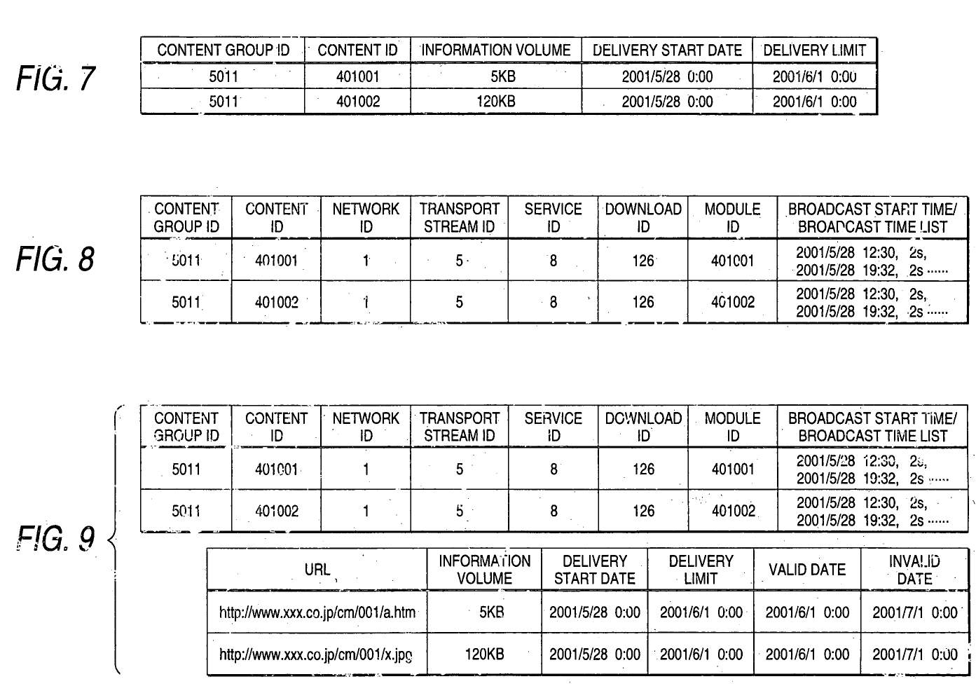

101: The content creation/delivery system 11 determines the content destination and sends a delivery request to a content sending coordinator 2. The content creation/delivery system 11 then sends content's accessory information shown in FIG. 3 and a content destination shown in FIG. 4, together with the content main body. The content's accessory information includes a content delivery start date, content information volume, URL of the content registered with the web server, a delivery limit time showing the broadcast limit time of the content, a valid date showing the date the content becomes valid, and an invalid date the content becomes invalid. The content destination includes the ID of the receiver 4 to which the content is directed.

The send content acceptance/management server 21 assigns a content ID to each material file as a content, and assigns a group ID to a group of contents such as an article or ad. FIG. 5 shows content's accessory information including content group ID and content IDs. As shown in FIG. 5, the content group 5011 is assumed consisting of the two contents 401001 and 401002 located at a.htm and x.jpg referenced therefrom.

102: The send content acceptance/management server 21 that has received a delivery request sends a content destination list with a content group ID appended shown in FIG. 6 to the destination list acceptance/management server 24. The destination list acceptance/management server 24 retains the content destination list.

103: When the delivery start date specified in the content's accessory information (FIG. 5) draws near, the send content acceptance/management server 21 issues a sending request to the data broadcast sending request system 22. In this practice, the send content acceptance/management server 21 passes the content main body and the content's accessory information in FIG. 5 to the data broadcast sending request system 22.

105: The 31 of the broadcast station 3 issues a sending request to the data broadcast programming system 32 that manages broadcasting schedules.

106: The data broadcast programming system 32, considering the vacancy in the broadcast schedule and delivery start date, delivery limit time and information volume of the content, determines the broadcast time for the content. The data broadcast programming system 32, after determination of the broadcast time, returns to the data broadcast acceptance system 31 the network ID, transport stream ID, service ID, download ID, module ID, broadcast start time/broadcast time list necessary for acquiring the contents at the terminal, together with the content group ID and content ID, as shown in FIG. 8. While the data carousel cycle and broadcast count are predetermined and the broadcast start time/broadcast time list is prepared accordingly in this example, the contents provider may specify the information as content's accessory information.

107: The data broadcast acceptance system 31 checks whether the information returned from the data broadcast programming system 32 is conforming, such as whether the broadcast schedule is within the delivery limit time. In case the information is conforming, the data broadcast acceptance system 31 returns the information in FIG. 8 as broadcast schedule information to the data broadcast sending request system 22 of the content sending coordinator 2.

108: The data broadcast sending request system 22 registers the broadcast schedule information and the content's accessory information as delivery schedule information with the data broadcast schedule management server 23. FIG. 9 shows the registered delivery schedule information.

201: (flow after step 107 but independent of step 108) In case the checkup in step 107 is OK, the data broadcast acceptance system 31 simultaneously passes the content main body retained by the data broadcast acceptance system 31 to the data broadcast programming system 32 in order to validate the sending schedule.

202: The data broadcast programming system 32 passes the content and the broadcast schedule to the data broadcast sending system 33 to make preparations for sending.

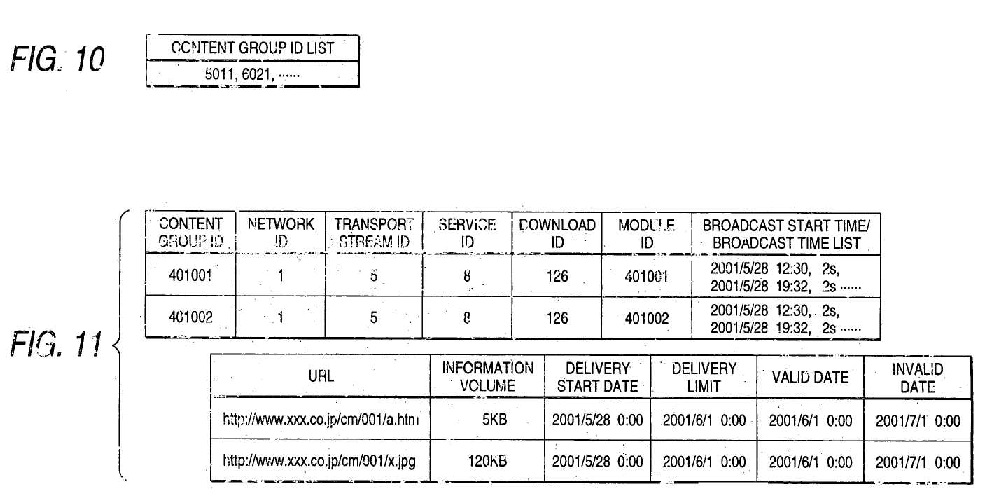

301: (flow after step 108 but discontinuous) The individual schedule creation/management server 25 is activated via an instruction from the manager or a timer to start creation of content delivery schedule information per terminal. The individual schedule creation/management server 25 acquires the content destination list (FIG. 6) that includes the terminal ID from the destination list acceptance/management server 24 based on the terminal ID, and prepares a content group list to be delivered to the terminal ID. FIG. 10 shows a content group list for the terminal ID 1001.

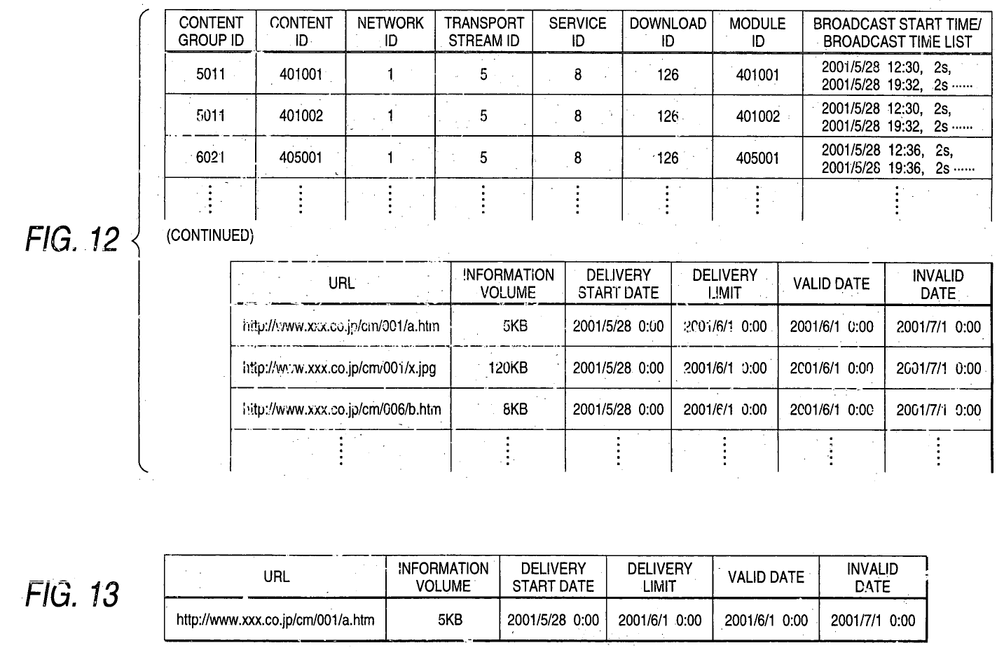

302: The individual schedule creation/management server 25 acquires the delivery schedule information of the contents acquired in step 301 from the data broadcast schedule management server 23. FIG. 11 shows an example of delivery schedule information acquired concerning the content group ID 5011. The individual schedule creation/management server 25 generates contents delivery schedule information per terminal based on the information acquired in steps 301 and 302. FIG. 12 shows an example of content delivery schedule information created for the terminal ID 1001.

401: (flow after step 302 but discontinuous) The schedule acquisition apparatus 42 of the receiver 4 is activated via a timer or an external instruction such as a broadcast and connects via the internet to the individual schedule creation/management server 25 of the content sending coordinator 2 by using the PPP (point-to-point protocol) over a telephone line, and requests content delivery schedule information (FIG. 12) corresponding to the local terminal.

402: The schedule acquisition apparatus 42 sends the content delivery schedule information received in step 401 to the content acquisition apparatus 41.

501: (flow after step 402 but discontinuous) The content acquisition apparatus 41 that has received content delivery schedule information receives a data broadcast wave in accordance with the broadcast schedule described in the information and acquires a content. The content acquisition apparatus 41 checks the acquired content against various ID information in the content delivery schedule information to identify the content, acquires the information including the URL, information volume, delivery start date, delivery limit time, valid date and invalid date from the content delivery schedule information, then sends the information to the internet cache apparatus 43 together with the content main body. FIG. 13 shows accessory information sent with the content main body from the content acquisition apparatus 41 to the internet cache apparatus 43.

The internet cache apparatus 43 manages the content main body and the accessory information in linkage and waits for a content request coming from an application 44.

601: (flow independent of the preceding flow) The application 44 on the receiver 4 makes a request to the internet cache apparatus 43 to reference a content on a network. Assume that an HTML document displayed using an HTML browser has a link to another HTML document on the network and the user selects the link. The HTML browser requests acquisition of the content from the internet cache apparatus 43 based on the URL described on the link (for example http://www.xxx.co.jp/cm/001/a.htm).

602: The internet cache apparatus 43 uses the content's accessory information (FIG. 13) to check whether the information has a content corresponding to the URL written in the content reference request sent in step 601 and, in case it has the content, checks whether the content is within the valid period (after the valid date and before the invalid date). In case the corresponding content is not found in the internet cache apparatus 43, it is also possible, if necessary, to connect the receiver 4 to the internet by using the PPP over the telephone line and request acquisition of the content specified by the URL from the web server 12 indicated by the URL (server located at www.xxx.co.jp in the case of http://www.xxx.co.jp/cm/001/a.htm) to obtain the content.

603: The internet cache apparatus 43 returns the requested content to the application 44. The application 44 plays back the content on the screen without identifying whether the content has been acquired via broadcasts or communications.

As mentioned earlier, in this embodiment, from among the broadcast contents uniformly delivered to viewers, in order to receive/accumulate specific contents at each terminal (each user), from two pieces of information, 1) (content information indicating) contents to be received at each terminal and 2) broadcast schedule of the content to be broadcast, it is possible to create individual receive information (content delivery schedule) as information indicating. Each terminal can acquire the information via a communications system thus allowing individual content reception from a broadcasting system.

That is, in the context of this embodiment, a receiver (terminal) receives a terminal-based content deliver schedule created from 1) content destination list specified by the content provider and 2) broadcast schedule of a broadcast content and each terminal receives and accumulates individual contents (contents to be received by the receiver) from among the contents to be broadcast based on the schedule. This allows efficient individual reception, or in other words, reception of different contents per terminal from broadcasts that provides high-speed volume delivery. This promises a great effect in applications.

Contents to be received by each terminal need not be specified by the content provider unlike mentioned in 1) but may be determined by reasoning from the taste information and history information of each terminal (each user).

In case the contents to be sent per terminal is transmitted via a broadcasting system and the broadcast schedule and the contents are acquired via a communications system, address information used to specify the contents (the corresponding URLs of the contents) is communicated via a communications system. At the terminal, contents are acquired in accordance with a broadcast schedule and the acquired contents are accumulated in a cache together with the corresponding URLs.

The application references the target URL in the cache to obtain the content. The cache returns the content to an application in case it is already acquired. Otherwise the cache acquires the content using the URL from the internet and transmits the content to the application.

Contents are transmitted via broadcasts in this system so that the volume of a content is not limited unlike in a communications system. Received contents are accumulated in a cache so that it is possible to readily respond to a content reference request issued from an application thereby allowing prompt display.

Transmission of a content via broadcasts allows simultaneous transmission of the same information to a large number of subscribing terminals, thus providing efficient information transmission and a more advantageous transmission cost.

Even in case a terminal has failed to receive a content that was broadcast, the terminal can acquired the content via the internet. This assures that the receiving party can acquire all the information of the contents to be provided. Thus, a content provider need not consider a content acquisition error in authoring of a content. In case a content is accessed from an application on the terminal, it is not necessary to consider whether all the contents have been acquired. Although there may be a case where the content that was broadcast cannot be accumulated only partially due to difference in the storage area of each terminal, such a case need not be considered in authoring of a content. This enhances the freedom of content creation.

In this system, a broadcast contents and an URL on the network are managed in linkage so that reference relationship between contents can be traced via URLs. Therefore, contents belonging to the same content group need not be broadcast from the same broadcast station at the same period. For example, HTML constituting a single web page may be broadcast by Station B and jpg by Station B and Station C, without disrupting the reference relationship after reception of the content.

Thus, in each broadcast station, it is possible to transmit a content in an idle time zone. Accordingly, a broadcast station can provide a paid service to transmit contents in an idle time zone on a business basis. A content provider, even a small-scale business, can use this foundation to deliver contents.

Specification of the broadcast system requires no modifications at all when this invention is applied.

Contents and URLs are managed in linkage so that it is possible to acquire a content via a communications system without contradiction even in case acquisition of a content via broadcasts has failed.

In order to avoid tapping of contents delivered via broadcasts, a content may be encrypted before it is delivered. The encryption may be done by a content sending coordinator or a broadcast station.

In case a content sending coordinator encrypts a content, it generates an key and encrypts a contents then makes a delivery request to a broadcast station.

In case a broadcast station encrypts a content, a coordinator generates an key and passes the key and a content to the broadcast station, which encrypts the content for later broadcast. Or, the content sending coordinator passes a content not yet encrypted to the broadcast station, which generates an key and uses the key to encrypt a content for later broadcast. Then the broadcast station returns the key to the coordinator together with the schedule.

The coordinator manages the key together with the schedule. The content sending coordinator inserts an key necessary for decoding in the individual schedule to be sent to a terminal, for the terminal to use the key to decode an incoming encrypted content. By doing this, it is possible to prevent the terminals other than one that should receive the target content from using the content. Embodiments of a broadcast system according to the invention is not limited to broadcasts via electric waves but includes a cable broadcasts such as a CATV and broadcasts on the internet such as the IP multicast.

(Second Embodiment)

The second embodiment describes the system where each broadcast station deploys a content transmission service business.

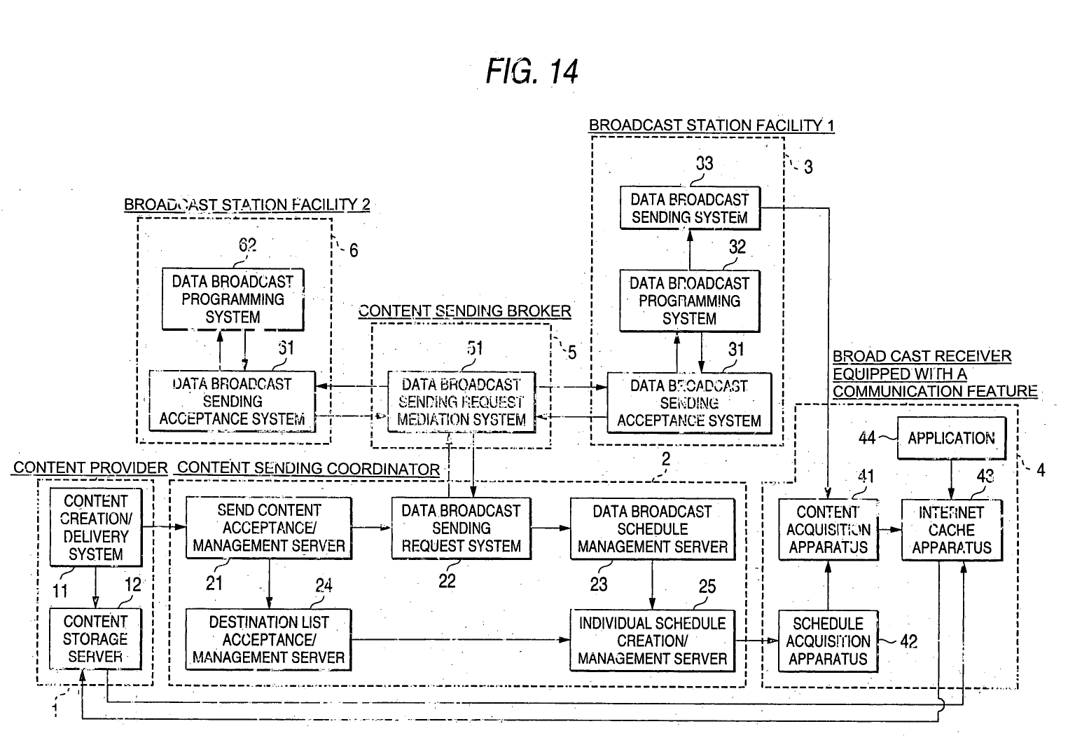

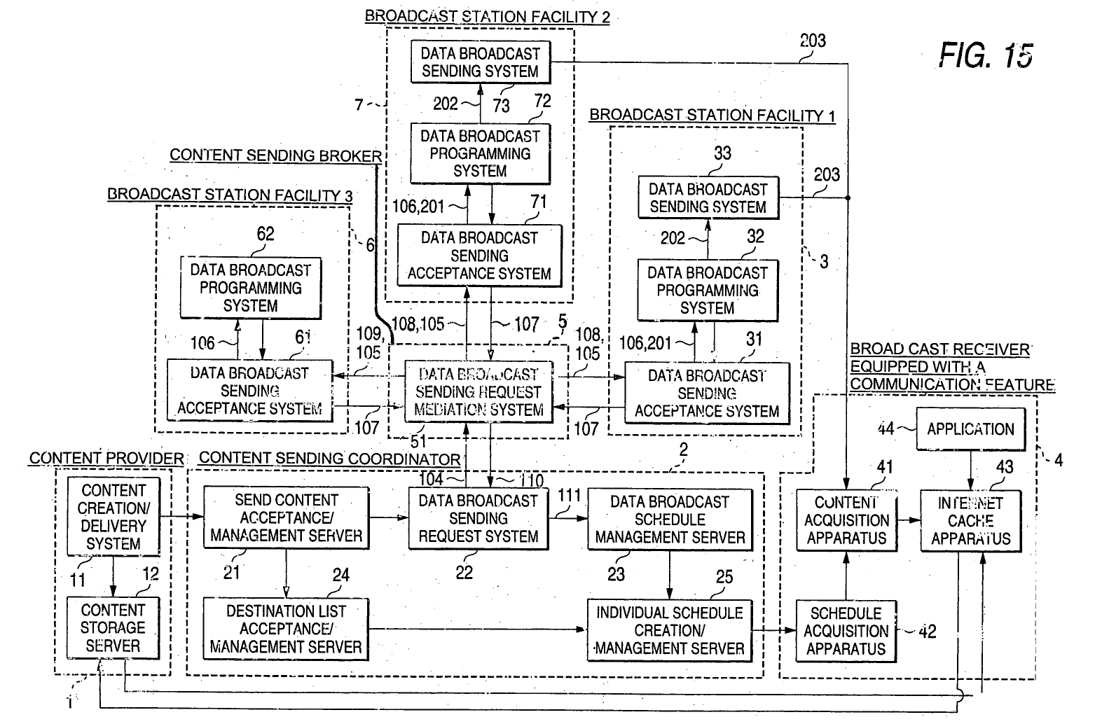

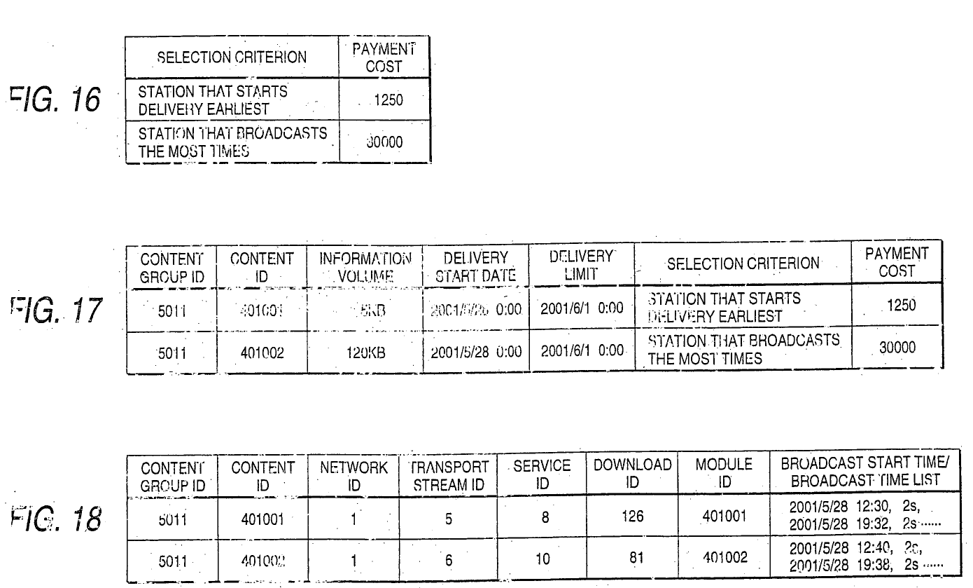

The information provision system, as shown in FIG. 14, comprises a content sending broker 5 having a data broadcast sending request mediation system 51. The content sending broker 5 mediates a content broadcast request by a content sending coordinator 2 between a plurality of broadcast stations 3, 6. The other configuration is the same as that of the first embodiment (FIG. 1).

Operation of the system will be described using FIG. 15. FIG. 15 explains the operation with numbers where the content sending broker 5 mediates a content broadcast request between a content sending coordinator 2 and broadcast stations 3, 6, 7.

Processing up to step 103 is the same as that in the first embodiment (FIG. 2). Note that, as shown in FIG. 16, a content provider 1 includes the criterion for selecting a broadcast station to broadcast the content and payment cost information in the content's accessory information (FIG. 3) then issues a delivery request to the send content acceptance/management server 21 of the content sending coordinator 2, and the send content acceptance/management server 21 appends a content group ID to the content's accessory information and issues a sending request to the data broadcast sending request system 22.

104: The data broadcast sending request system 22, as shown in FIG. 17, sends a content group ID, information volume, delivery start date, delivery limit time, selection criterion and payment cost information as well as a content main body to the data broadcast sending request mediation system 51 of the content sending broker 5 to request data broadcasts.

105: The data broadcast sending request mediation system 51 sends a data broadcast bidding guide together with the information in FIG. 17 to the data broadcast acceptance system 31, 71, 61 of each broadcast station 3, 6, 7. In case the selection criterion is the minimum delivery cost, unlike this example, the payment cost information (maximum payment amount and interpretation) may be left secret to a broadcast station. In case the delivery cost is made uniform between broadcast stations, the payment information need not be sent.

106: The data broadcast acceptance system 31, 61, 71 of each broadcast station arranges the timing of broadcast with data broadcast programming system 32, 62, 72 that manages the broadcast schedules based on the information volume, delivery limit time and bidding selection criterion described in the guide. In this example, selection criterion of the content ID 401001 is to start delivery earliest. Thus, the 31, 61, 71 makes a request to the data broadcast programming system 32, 62, 72 to issue a schedule where delivery is started with the timing closest to the delivery limit time 2001/5/28 0:00 and receives a schedule from the data broadcast programming system 32, 62, 72.

107: Each broadcast station validates the broadcast schedule and generates bidding information shown in FIG. 18 and returns the information to the data broadcast sending request mediation system 51. In case the selection criterion is the minimum delivery cost unlike this example, the delivery cost is included in the bidding information.

108: The data broadcast sending request mediation system 51 compares bids of broadcast stations gathered, based on the selection criterion and communicates a successful bid to the most conforming broadcast station. In this practice, the data broadcast sending request mediation system 51 also sends the content main body. Assume that the content ID 401001 is knocked down to first Broadcast Station 3, the content ID 401002 to second Broadcast Station 7 and third Broadcast Station 6 failed in the bid in this example.

109: The data broadcast sending request mediation system 51 communicates failure in the bid to the broadcast station 6 that made a bid but failed. In response to this, the data broadcast sending acceptance system 61 takes measures such as broadcast schedule reservation cancellation and makes preparations for the next bid guide.

110: The data broadcast sending request mediation system 51 returns the information presented by the broadcast station that succeeded in the bid as broadcast schedule information to the data broadcast sending request system 22. Information same as that in FIG. 18 is returned to the data broadcast sending request system 22.

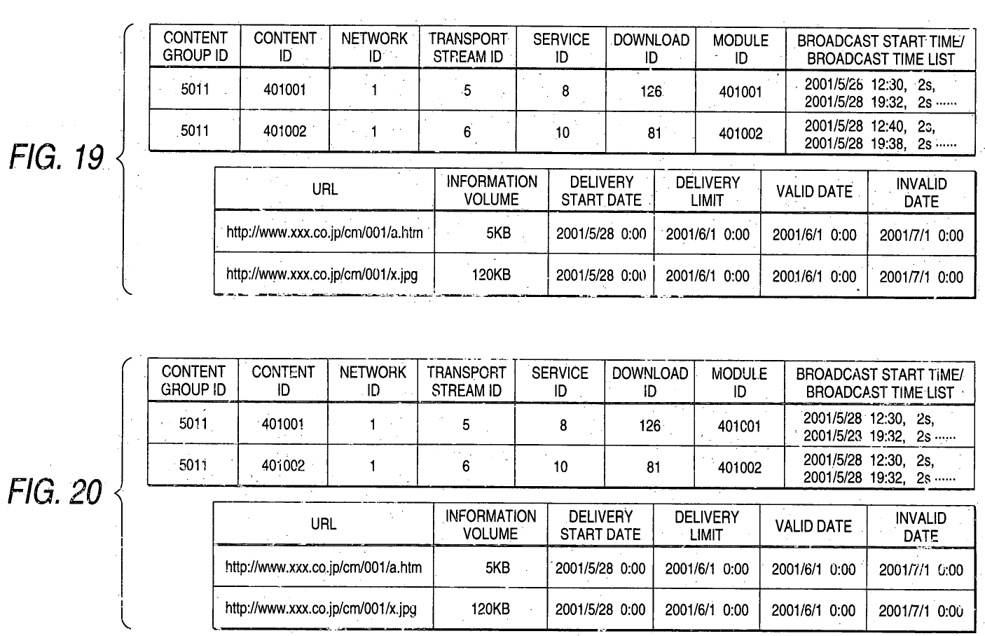

111: The data broadcast sending request system 22 registers the result returned in step 110 with the data broadcast schedule management server 23. Registered information is shown in FIG. 19.

201: (flow after step 109 but independent of step 110) When successful bid is communicated in step 109, the data broadcast acceptance system 31, 71 passes the content and the broadcast schedule to the data broadcast sending system 33, 73 to make preparations for transmission.

202: The data broadcast programming system 32, 73 pass the content and the broadcast schedule to the data broadcast sending system 33, 73 to make preparations for sending.

203: The data broadcast sending system 33, 73 broadcasts the content over an electric wave in accordance with the specified broadcast schedule.

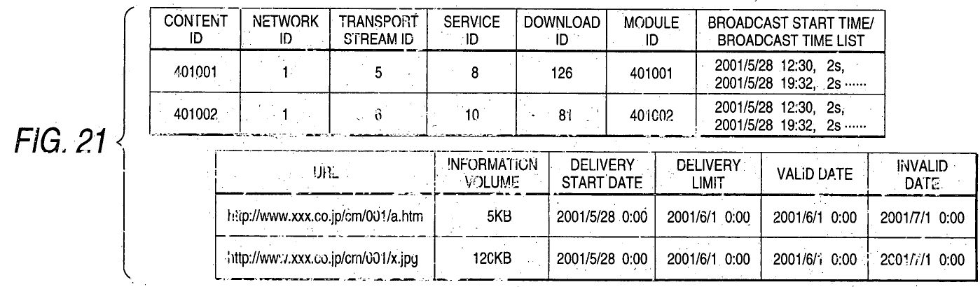

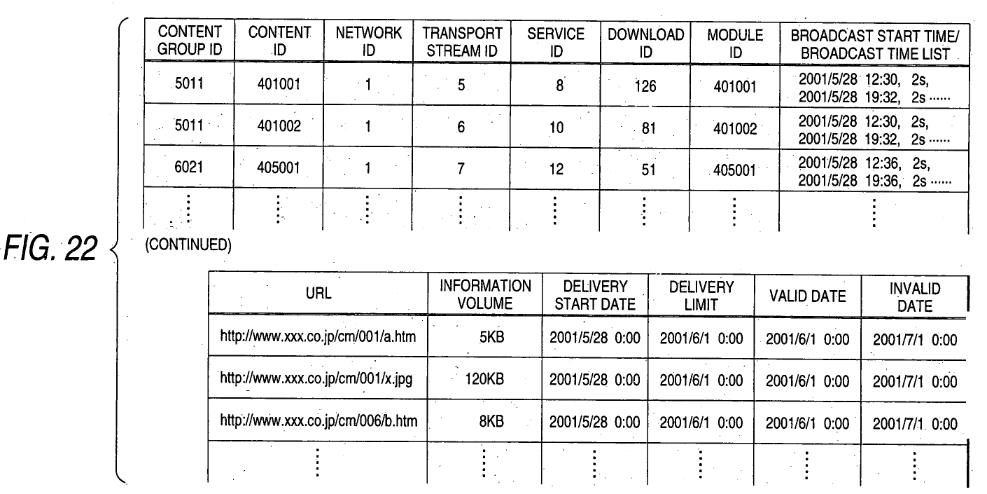

The flow after step 301 is the same as that in the first embodiment. FIG. 20 shows delivery schedule information registered with the data broadcast schedule management server 23. FIG. 21 shows an example of deliver schedule information acquired in relation to the content group ID 5011. FIG. 22 shows an example of content delivery schedule information created for the terminal ID 1001. Note that content ID 401001 and the content ID 401002 are broadcast from separate broadcast stations thus the corresponding transport stream IDs, service IDs, and download IDs differs from each other.

In this way, in this information provision system, via mediation by a content sending broker, it is possible for a broadcast station to smoothly operate the foundation on which the broadcast station executes a content transmission service in idle broadcast time zones. This system gives birth to a new business called a content sending broker.

While a content sending coordinator and a content sending broker are separately provided in this embodiment, a content sending coordinator may also act as a content sending broker.

(Third Embodiment)

The third embodiment describes a system where transmission of a content is allocated to a broadcast system or a communications system.

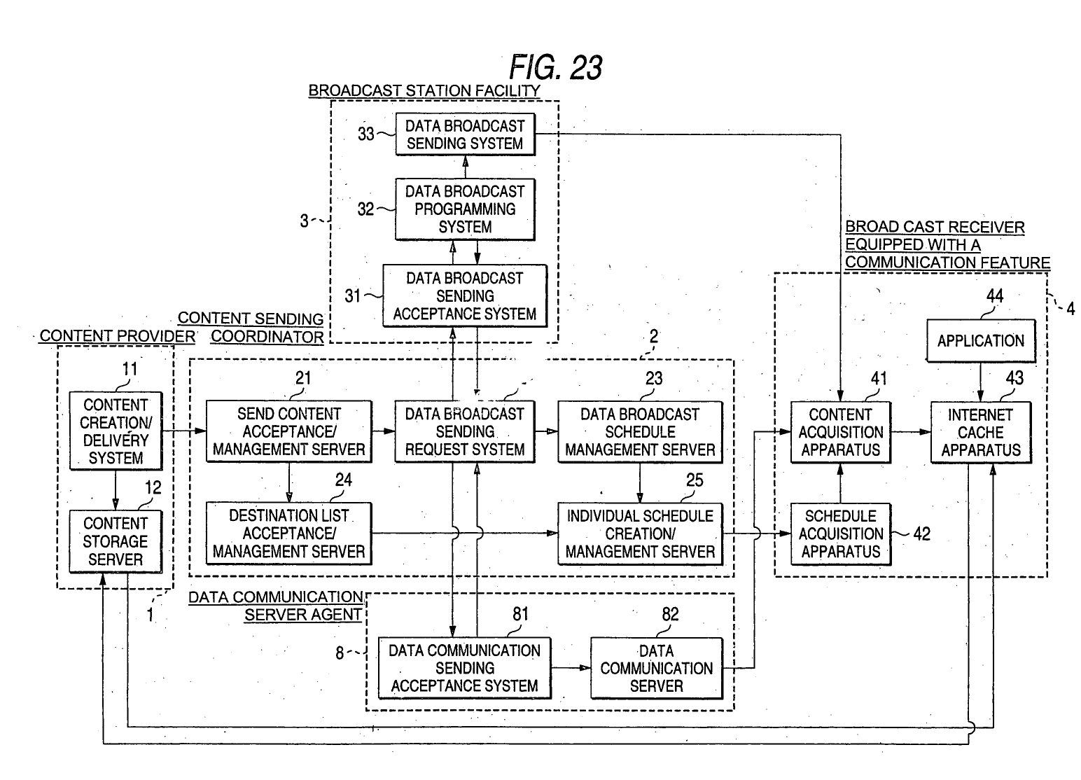

This system comprises, as shown in FIG. 23, a data communication server agent 8 that transmits a content to a receiver 4 via a communications system. The data communication server agent 8 comprises a data communication sending acceptance system 81 for accepting transmission of a content and a data communication server 82 for accumulating contents to be sent. The other configuration is the same as that of the first embodiment (FIG. 1).

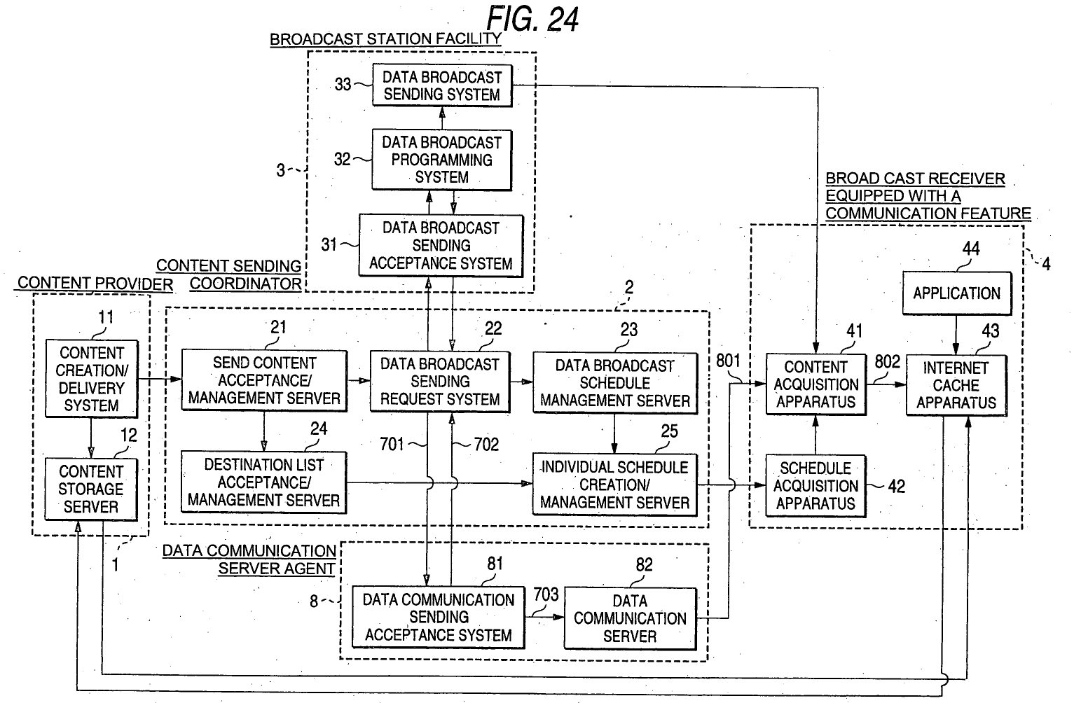

Operation of the system will be described using FIG. 24. FIG. 24 explains the operation related to the data communication server agent 8 in FIG. 23 with numbers.

Processing up to step 102 is the same as that in the first embodiment (FIG. 2).

103: When the delivery start date specified in the content's accessory information (FIG. 5) draws near, the send content acceptance/management server 21 issues a sending request to the data broadcast sending request system 22. In this practice, the send content acceptance/management server 21 passes the content main body and the content's accessory information (FIG. 5) and the destination list (FIG. 6) to the data broadcast sending request system 22.

104: The data broadcast sending request system 22 calculates the cost of delivery via broadcasts and the cost of delivery via communications based on the number of destinations and information volume on a per content basis, then compares these costs with each other. In case the number of destinations is small and delivery cost is lower via communications with telephone charge than via broadcasts and the telephone line of the user that owns the terminal is occupied for a small amount of time by small traffic, the data broadcast sending request system 22 determines that the information be sent via a communications system. Otherwise, the information is sent via a broadcast system. In case the information is sent via a broadcast system, execution proceeds to step 701. In case all the broadcast stations have responded that broadcast is impossible although the information is determined to be sent via a broadcast system, another choice is to send the information via a communications system. In this case, “deliver impossible” is returned in step 107 in the first embodiment then execution proceeds to step 701.

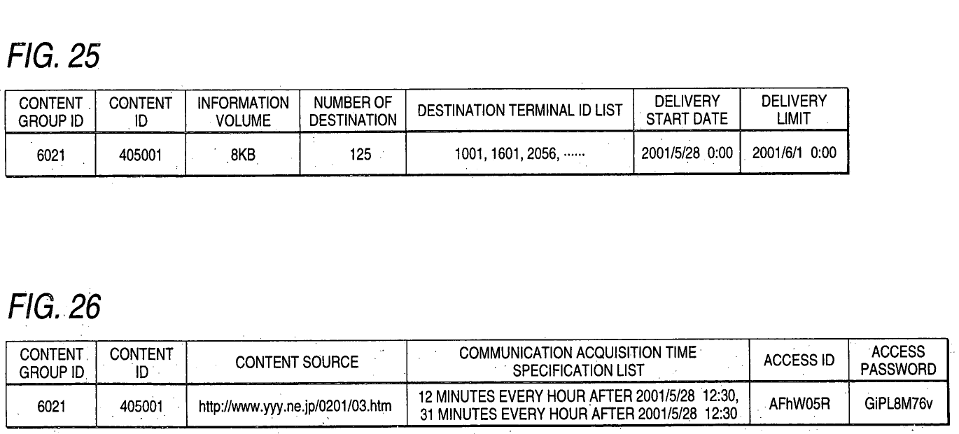

701: In case it is determined that a content be sent via a communications system in step 104, the data broadcast sending request system 22 sends the content main body and the accessory information shown in FIG. 25 to the data communication server agent 8 and makes a request to place the data in the data communication server 82. The content's accessory information in FIG. 25 includes a content group ID, a content ID, information volume, number of destinations, a destination terminal ID list, a delivery start date, and a delivery limit time.

702: The data communication sending acceptance system 81 of the data communication server agent 8 determines the position on the data communication server 82 to store contents. The data communication sending acceptance system 81 assigns an acquisition timing of the receiver 4 considering the number of destinations so that content requests coming from the receiver 5 will not simultaneously flood on the data communication server 82. The data communication sending acceptance system 81 then returns the result as communications schedule information to the data broadcast sending request system 22 of the content sending coordinator 2. The communications schedule information includes, as shown in FIG. 26, a content group ID, a content ID, a content acquisition source representing the location of the content placed on the data communication server 82, a communication acquisition time specification list for specifying the timing when the receiver 4 fetches the content from the data communication server 82, and an access ID and an access password used to access the data communication server 82. The URL (http://www.yyy.ne.jp/0201/03.htm) means the location of a content placed on the data communication server 82 in FIG. 23.

703: The data communication sending acceptance system 81 stores the content main body in a location on the determined data communication server 82. The content is stored until the delivery limit time and waits for content acquisition by the receiver 4. The content is discarded when the delivery limit time is reached.

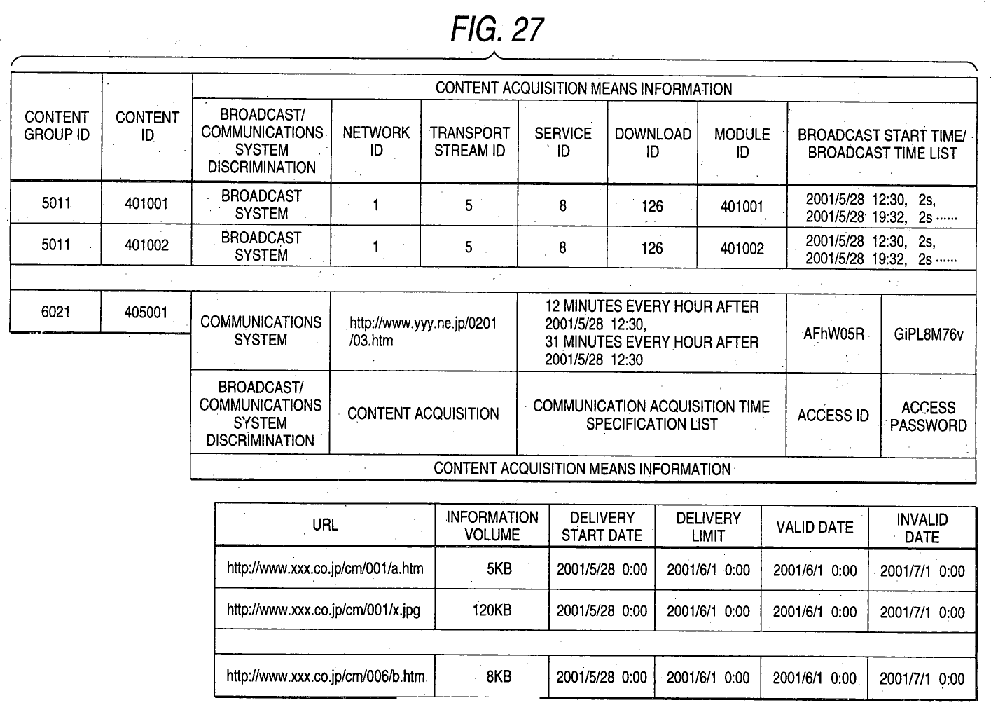

The data broadcast sending request system 22 registers delivery schedule information (FIG. 27) composed of broadcast schedule information and communications schedule information and content's accessory information with the data broadcast schedule management server 23.

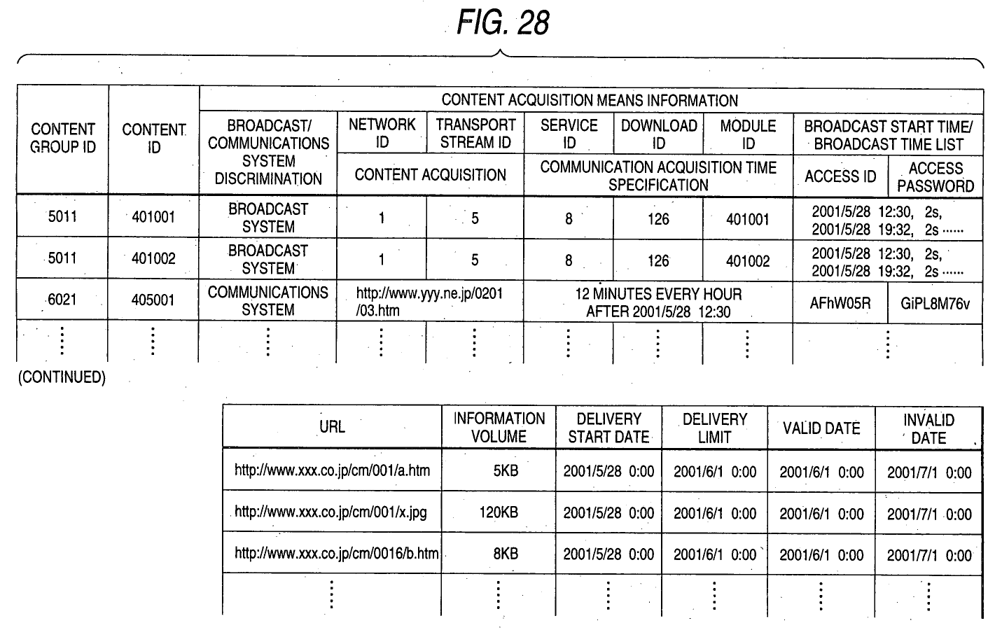

The individual schedule creation/management server 25 creates terminal-based content delivery schedule information (FIG. 28).

The schedule acquisition apparatus 42 of the receiver 4 receives the content delivery schedule information and sends the information to the content acquisition apparatus 41.

801: The content acquisition apparatus 41, receiving content delivery schedule information, in case “broadcast/communications system discrimination” of “content acquisition means” in the content delivery schedule information contains a content to be acquired via a communications system, connects to the internet via PPP connection using a telephone line when the time specified in “communication acquisition time specification” is reached and uses the URL specified in “content destination” to acquire the content. The connection in this practice uses the toll free dialing service in order not to burden the user of the receiver with communication charge. The content acquisition apparatus 41 authenticates the terminal using an access ID and a password in order to prevent unauthorized use before PPP connection via toll free service. This prevents access from terminals other than an authorized receiver and also prevents access to an authorized content by managing access IDs and content IDs that can be acquired on the data communication server 82 and limiting access to URLs other than those candidate for acquisition.

802: The acquired content is registered with the internet cache apparatus 43, together with information similar to that in FIG. 13.

In this way, the information provision system can select either a broadcast system and a communications system, which ever is advantageous in the delivery of contents before delivering contents.

The terms “system,” “module”,” “server,” and “apparatus” are for exemplary purpose only and an “individual schedule creation/management server” maybe implemented as an “individual schedule creation/management module,” in an alternative way. These terms may be implemented as a single feature (software feature) of apiece of hardware or as a separate piece of hardware.

<Industrial Applicability>

As understood from the foregoing description, an information provision system according to the invention can effectively transmit information to be provided to a terminal even in case information requested by terminals differs from terminal to terminal, and thus the system is advantageous in terms of the transmission cost.

A terminal can acquire all the information provided without loss by way of a broadcast system or a communications system. (Each content is stored with its URL in a cache thus eliminating the workload of unnecessary network reference.

As a result, a content provider need not consider a content acquisition error in authoring of a content, thus enhancing the freedom of content creation.

A broadcast station can effectively use the idle broadcast time zones or idle bandwidths to provide a content transmission service as a business lineup. A content provider, even a small-scale business, can use this foundation to deliver contents via broadcasts.

This system also gives birth to a new business called a content sending broker for smoothly operating the foundation.

1. An information provision system that provides a content destined for a terminal, said content created by a content provider,
in that individual receive information necessary for transmitting said content to the terminal via a broadcast system and receiving said content via a broadcast system is transmitted to said terminal via a communications system.

2. An information provision system according to claim 1, wherein said individual receive information includes address information used in case said content is acquired via a communications system.

3. An information provision system according to claim 2, wherein said terminal manages said content in linkage with said address information.

4. An information provision system according to claim 2, wherein said address information is an internet URL.

5. An information provision system according to any one of claims 2 through 4, wherein said terminal acquires a content via a communications system based on said address information, which content the terminal failed to receive via a broadcast system.

6. An information provision system that provides a content destined for a terminal, said content created by a content provider, said information provision system comprising:
a broadcast station for broadcasting said content via data broadcasts and
a content sending coordinator for requesting broadcast of a content created by said content provider from said broadcast station, acquiring from said broadcast station the individual receive information as information necessary for receiving said content, and presenting said information to a terminal via a communication circuit.

7. An information provision system that provides a content destined for a terminal, said content created by a content provider, said information provision system comprising:
a plurality of broadcast stations for broadcasting said content via data broadcasts,
a content sending coordinator for requesting broadcast of a content created by said content provider, acquiring from a broadcast station that broadcasts said content the individual receive information as information necessary for receiving said content, and presenting said information to a terminal via a communication circuit, and
a content sending broker for selecting, in response to a request from said content sending coordinator, a broadcast station that broadcasts said content.

8. An information provision system according to claim 6 or 7, wherein said content provider accumulates said created content onto a server on a network, that said content sending coordinator includes the address information of said content on the network in said information to be presented to a terminal, and that said terminal manages a content received via data broadcasts in linkage with said address information.

9. An information provision system according to claim 8, wherein said terminal acquires a content from said server on a network based on said address information, which content the terminal failed to receive via data broadcasts.

10. An information provision system according to claim 7, wherein said content sending broker individually selects broadcast stations that can broadcast a related plurality of contents under the conditions suited for each content in order to let the stations broadcast the contents.

11. An information provision system that provides a content destined for a terminal, said content created by a content provider, said information provision system comprising:
a data communication server agent for accumulating said content onto a server on a network as well as setting access information to said server and
a content sending coordinator for requesting accumulation of a content created by said content provider and presenting said access information set by said data communication server agent to a terminal via a communication circuit.

12. An information provision system that provides a content destined for a terminal, said content created by a content provider, said information provision system comprising:
a broadcast station for broadcasting said content via data broadcasts,
a data communication server agent for accumulating said content onto a server on a network as well as setting access information to said server, and
a content sending coordinator for requesting broadcast or accumulation onto a server of a content created by said content provider and presenting information necessary for receiving said content via broadcasts or information necessary for accessing said server to a terminal via a communication circuit,
and that said content sending coordinator considers the content transmission cost, transmission time, traffic on the transmission path, and transmission data size before selecting said broadcast station or data communication server agent.

13. An information provision system according to claim 11 or 12, wherein said data communication server agent sets the access timing to said server and that said terminal acquires a content from said server in accordance with the access timing set by said data communication server agent.

14. A content sending coordinator of an information provision system according to claim 6, wherein said content sending coordinator comprises a send content acceptance/management section for accepting a content from said content provider and managing the content,
a destination acceptance /management section that accepts and manages destination information of a content to be received that is determined based on the history information or taste information of a terminal that receives the content or the user of the terminal,
a data broadcast sending request section that requests broadcast of a content from said broadcast station and receives its schedule,
a data broadcast schedule management section that manages the schedule received from said broadcast station, and
an individual schedule creation/management section that creates a broadcast schedule of contents per terminal from the destination information of said destination acceptance/management section and the schedule information of said data broadcast schedule management section and manages the schedule.

15. A broadcast station of an information provision system according to claim 6, wherein said broadcast station comprises a data broadcast sending acceptance section for accepting a content sending request coming from said content sending coordinator, a data broadcast programming section for creating a sending schedule of a requested content, and a data broadcast sending section for data-broadcasting a content in accordance with a created schedule.

16. A terminal of an information provision system according to claim 6, wherein said terminal comprises a schedule acquisition section for acquiring a content broadcast schedule from said content sending coordinator, a content acquisition section for acquiring a data-broadcast content based on said schedule, a cache section for accumulating an acquired content, and communication means for acquiring lacking contents from a server on a network.

17. A content sending broker of an information provision system according to claim 7, wherein said broker comprises a data broadcast sending request mediation section for mediating the broadcast request of said content between a plurality of stations.

18. An information provision system according to claim 6 or 7, wherein said broadcast station broadcasts said content that has been encrypted and that said content sending coordinator transmits a key necessary for decoding said encrypted content to said terminal via a communication circuit.

19. An information provision system according to claim 18, wherein said content sending coordinator generates an encryption key to encrypt a content and requests broadcast of the encrypted content from said broadcast station.

20. An information provision system according to claim 18, wherein said content sending coordinator passes a content and an encryption key to said broadcast station and that said broadcast station encrypts said content by using said encryption key for broadcasts.

21. An information provision system according to claim 18, wherein said broadcast station generates an encryption key and encrypts said content to be broadcast, and passes a key necessary for decoding said encrypted content to said content sending coordinator.

22. An information provision system according to claim 1, 6, or 7, wherein said individual receive information is created by
a broadcast schedule of a content to be broadcast,
destination information of a content specified by a content provider, or
receive content information as destination information of a content to be received that is determined based on the history information or taste information of a terminal or the user of the terminal.

23. A receiver that receives a broadcast content as a content to be transmitted via a broadcast system, wherein said receiver acquires via a communications system the individual receive information created from
a broadcast schedule of a content to be broadcast,
destination information of a content specified by a content provider, or
receive content information as destination information of a content to be received that is determined based on the history information or taste information of the receiver or the user of the receiver,
and that the receiver receives said receive content among broad cast contents based on said individual receive information.
